(19) United States
(12) Patent Application Publication
(10) Pub. No.: US 2026/0289586 A1
(43) Pub. Date: Sep. 24, 2026

(54) METHODS FOR ESTABLISHING PRODUCT AUTHENTICITY

(71) Applicant: Henry Guy Stevens, Cheltenham (GB)

(72) Inventor: Henry Guy Stevens, Cheltenham (GB)

(21) Appl. No.: 19/472,129

(22) PCT Filed: Apr. 5, 2024
(86) PCT No.: PCT/GB2024/050922

§ 371 Date: Oct. 3, 2025

(30) Foreign Application Priority Data
Apr. 5, 2023 (GB) 2305084.2

(51) Int. Cl. G06Q 30/018; G06K 19/06; G06K 19/14

(52) U.S. Cl. CPC G06Q 30/0185; G06K 19/06084; G06K 19/0614; G06K 19/14

(57) ABSTRACT

There is provided a method of encoding a pre-existing product identifier or barcode for an authentic product, by determining a combination of taggants to correspond to that pre-existing product identifier or barcode, where the pre-existing product identifier or barcode includes a set of characters. The method comprises providing a list of different taggants which have various mutually distinguishable emission peaks, and assigning a different taggant to each character of the product identifier, for addition of that combination of taggants to a product to denote the product identifier.

The present invention relates to a first method of encoding a pre-existing product identifier (or pre-existing barcode) for an authentic product by determining a combination of taggants to correspond to that pre-existing product identifier or barcode, and a second method involving acquiring at least part of an emission spectrum of a product for use in assessing or determining whether the product is an authentic product having a combination of taggants (optionally determined by the first method).

### BACKGROUND TO THE INVENTION

Across many sectors of technology, there are high-end products or materials which tend to be more expensive and may have specialist properties, such as higher purity, greater durability or suitability for extreme operating conditions, for example. Similarly, there are mid-range or low-end products or materials which tend to be less expensive, and do not necessarily have the same properties as the high-end products or materials. There is no international standard for easily establishing that the right quality, grade and specification of production material has been used in a given product.

Counterfeit high-end goods can be obtained on the black market, although they tend to have visible differences to the genuine article. In cases where there is no visible difference between high-and low-end merchandise, this provides an opportunity to fraudulently substitute the high-end item for a lower quality product or material.

Sub-contracted work can have narrow profit margins, which can incentivise the sub-contractor to save money where possible, often by providing or using a cheaper product to the one specified. The lack of visible difference between the products or materials makes it difficult for the customer or regulatory authority to verify that the correct product or material has been used. This is particularly applicable to paints and coatings, which are generally difficult to distinguish when dry. However, the same is true of a variety of other products including textiles, tiles, fire-resistant cladding, and petrochemical products such as fuels or lubricants, to name just a few. Renewables or consumables of many kinds are also susceptible to fraud of this nature.

It can be critical to use an authentic product, rather than a third-party substitute product, in scenarios where safety is paramount and/or a certain degree of redundancy is required. For example, a particular product or component part of a product may be ‘over-engineered’, whether for safety or some other reason, and a different product or part may not suffice. This issue applies particularly to aircraft parts and other areas of the aerospace industry, where an item's authenticity is currently defined by its accompanying paperwork linking a reference number on the product or packaging. This system is relatively robust, but it cannot guarantee that the product matches the paperwork. It is an assumed factual statement from the manufacturer but, without destructive analysis, it cannot be proven to be the authentic product.

It is also important for there to be traceability in military supply chains, to mitigate the risk that counterfeit products/parts are used or installed in military equipment. The term counterfeit is used to refer to any non-authentic product or part, but particularly parts that are sub-standard and/or compromised, for example by a hostile actor. The scale of a defence department's supply chain can make monitoring for and intercepting counterfeit parts a daunting task. A department of defence only has visibility so far down the chain, without necessarily having oversight of who its prime manufacturers choose as suppliers. For example, the F-35 fighter jet's problems in summer 2022 shone new light on the Pentagon's complex supply chain and how opaque it can be to the department. The US Air Force (USAF) depends on about 12,000 direct suppliers, but further down the supply chain, the network expands to about 1 million companies.

More generally, whilst it is possible to take a sample and analyse its properties, this sort of testing takes a significant amount of time and effort, requires off-site testing and equipment, and tends to destroy the sample. This is highly unsuitable for paints and coatings. Even if the product can be tested to check its composition or properties, this does not conclusively prove exactly which product by which manufacturer has been used.

It is an object of the present invention to reduce or substantially obviate the aforementioned problems.

### STATEMENT OF INVENTION

According to a first aspect of the present invention, there is provided a method of determining a combination of taggants to correspond to a product identifier or barcode for an authentic product, the product identifier comprising a set of characters, the method comprising the steps of:
a) providing a list of a plurality of different taggants, where each taggant has an emission spectrum comprising one or more peaks, and the one or more peaks (in a given wavelength range) in the emission spectrum of a given taggant in the list are substantially distinguishable from the one or more peaks (in the same wavelength range) of emission spectra of the other taggants in the list;
b) for each character, assigning a taggant from the list to the character, each character in the product identifier thereby being associated with a different taggant, for addition of that unique combination of taggants to a product to chemically or spectrally denote the unique product identifier; and
c) optionally, obtaining or recording an emission spectrum of the assigned taggants or the combination of assigned taggants for pairing with the product identifier.

Claim 1 defines a preferred version of the first aspect of the invention.

Optional features are set out in the dependent claims.

The invention provides a covert means of marking a product. It allows for in-situ verification of product authenticity. The combination of taggants provides security, traceability and protection for manufacturers and consumers against counterfeits. It complements current barcoding technology which is widely accepted and has been in use for over 50 years. It provides a simple, globally accessible means of establishing product authenticity and is expected to support a standard regulatory mechanism for identifying approved materials and protecting against fraud.

The above method allows for taggants to be selectively formulated according to a pre-existing barcode. In other words, the taggant emission spectrum (or colour spectrum) is formulated to match the barcode or other identifier of the finished product. One taggant combination or formulation is provided per barcode or product identifier.

By formulating a taggant combination having a distinct combination of wavelength emissions, the overall emission spectrum can be matched or paired to the barcode of the product. In other words, for a product having a barcode or other unique identifier, a taggant combination can be prepared which intrinsically corresponds to or denotes that barcode by means of the emission spectrum of the taggant combination (or the emission spectra of the taggants).

It should be noted that it is preferred to obtain or record the infrared emission spectrum of the combination of taggants. That is, an infrared signature from all of the taggants in the specific combination when they are provided together, for example as part of the same particle or nanoparticle. This is because the infrared emission spectrum acts as a fingerprint for the specific combination of taggants, and can have characteristics that are not evident if simply combining discrete infrared emissions or signatures of each selected taggant recorded in isolation.

The emission spectrum may be recorded using ftir (fourier-transform infrared spectroscopy).

The step of recording the emission spectrum (preferably in a database) is particularly useful where the combination of taggants used gives rise to an emission spectrum which is more than the sum of its parts. That is, where the emission spectrum of the combination of taggants provided together is different to a simple summation or accumulation of the individual emission spectra of those taggants (when taken in isolation from each other). However, the individual emission spectra can in some examples be recorded, or known emission spectra can be accessed or relied on without the need to record the spectra ab initio.

When added to a solid or liquid product (or material), e.g. during manufacture, the combination of taggants provides an integral barcode within the product so that it is possible to later authenticate the identity of the exact product present. This can help identify where a product has been substituted, or to provide traceability in the case of events such as fuel spills or fires (such as the Grenfell fire in the UK).

The taggant composition may be considered to be covert in the sense that a competitor or counterfeiter would find it extremely difficult or time-consuming to identify and copy them. That is, it is almost impossible to reverse engineer the precise combination of taggants that gives rise to the ‘spectral barcode’ or spectral signature (or fingerprint) for a particular product.

Any one, some or all of the taggants may be provided in the form of nanoparticles.

The different taggants in the combination for a given product may be provided as composite nanoparticles, for example. That is, particles containing the assigned taggants. Such composite taggants can be created by a known process. This can simplify inclusion of the taggant combination in a product, such that there is a lower number of different composite nanoparticles to include in a product than the total number of different taggants making up the combination. In some embodiments, a given composite nanoparticle may comprise all of the assigned taggants for a particular encoded identifier/barcode.

The taggant combination determined by the method can then be added to any suitable product or material, such as any of paint, ink, plastic (whether thermoset or thermoplastic), plastic or polymer such as liquid polymer (whether air-dried or catalyst-cured), paper, additive manufacturing reagent, or another material or product, for example.

The invention has potential application for plastics identification, pharmaceutical and medical devices, industrial manufacturing, the automotive industry, consumer goods, firearms identification and/or traceability, and clothing and accessories, amongst others. More generally, the invention has potential application for any of the following: component identification and tracking, as an anti-counterfeit solution, manufacturing traceability, regulatory compliance, and/or brand identification.

The invention has potential application in the aerospace industry, such as for identification of aircraft parts. In that case, the method in the first aspect may be part of a method of manufacturing aircraft or aerospace equipment or components therefor.

The invention has potential application in military supply chains, such as for traceability of components intended for military use. In that case, the method in the first aspect may be part of a method of manufacturing military equipment or components therefor.

It will be appreciated that emission spectrum peaks arising from different taggants may be distinguishable from ‘noise’ (such as low or non-coherent emission response) in each spectrum, and may be distinguishable from each other in various ways. That is the peaks of the various taggants may be mutually distinguishable from each other. It is possible to use taggants which have multiple and/or overlapping peaks, subject to those peaks being sufficiently distinguishable from each other.

For example, emission spectrum peaks of certain taggants may not overlap each other, or may be distinct, making identification facile. In some examples, emission spectrum peaks may be centred at different wavelengths. In some examples, emission spectrum peaks may have different peak widths (that is, how narrow or wide the peak is in terms of its wavelength range). That is, the sharpness or broadness of a given peak may vary by taggant. In some examples, emission spectrum peaks may have different intensities according to the amount of taggant present and/or the excitation wavelength(s) used. In some examples, a peak or peaks may be part of a multi-peak signal, which may be uniquely associated with a particular taggant. In some examples, peak intensities taken at points to either side of the peak maximum may indicate a degree of peak asymmetry, which may help differentiate between different taggants.

Any one, some or all of the above factors may be used to distinguish peaks of one taggant from those of another taggant. This may be useful where there is a degree of overlap or similarity between the emission spectra of two or more taggants in a given combination of taggants.

It will be appreciated that the present invention is directed towards emission spectra in involving ultraviolet, visible and infra-red light. That is, generally involving excitation of outer shell electrons using suitable wavelengths of light, and then detecting emitted light in those ranges, ideally in the visible (400-700 nm) or near infra-red (700-1000 nm) ranges.

Near infra-red emissions can be detected more easily so may be preferred. It will be appreciated however that UV or visible light emissions may be relied on instead. Similarly, it will be appreciated that Raman spectra may be used to put the invention into effect.

In some preferred embodiments, the present invention is directed towards infrared emission using excitation wavelengths in the near infrared, for example at 950 nm or longer. The excitation wavelengths may be up to about 25000 nm. In some cases, the wavelengths may be any of: about 1050 nm or longer, about 1400 nm or longer, about 1600 nm or longer, or about 1930 nm or longer. In some cases, the wavelengths may be up to about 15000 nm. Any subrange in the range 950 nm to 25000 nm may be selected using an independent selection of any of these wavelengths as upper or lower boundaries.

The method may exclude obtaining or recording one or both of: an ultraviolet light spectrum of the combination of taggants, and a visible light spectrum of the combination of taggants.

The method may include the step of encoding at least part of the set of characters of the product identifier to provide a set of encoded characters.

The combination of taggants may thus be directly associated with the encoded characters, rather than the characters of the product identifier.

The product identifier may be an existing barcode in a database. The identifier or barcode may be pre-assigned to a product already. In other words, the barcode may already be on products for sale, or may have been allocated to a product projected to soon be on sale. The database may be a Global Trade Item Number (GTIN) database or a Universal Product Code (UPC) database. These databases are merely examples of global repositories of product identifiers, and any suitable repository may be used.

Formulating a taggant combination to match an existing barcode in a global database avoids the need to re-assign a new barcode to existing stock of a product, and the need for corresponding system updates for a potentially large number of people/companies.

The relevant parts of the emission spectra may each be in the visible light and/or near-infrared light range.

Emission wavelengths of peaks of the taggants may be substantially in the range 400 nm to 800 nm. Emission wavelengths of peaks of the taggants may be substantially in the range 700 nm to 1000 nm. Near infra-red peak emissions may be preferred because they can be more easily sensed or distinguished.

In some preferred embodiments, excitation wavelengths may be substantially in the range 950 nm to 25000 nm, or a subrange thereof. Corresponding infrared emissions may then be recorded.

Each character may be encoded to a two-part encoded character, such as a pair of letters or numbers (or an alphanumeric pair). Each character may be encoded based on its position within the order of characters in the product identifier.

This allows for encoding more information than just the numbers, letters and/or symbols present in the product identifier or barcode. Thus, two barcodes containing the same digits in a different order will have different taggant combinations.

Each character may be encoded by means of a conversion table. The conversion table may contain a set of two-part encoded characters. The first part of each encoded character may be a horizontal identifier for the table. The second part of each encoded character may be a vertical identifier for the table. There may be ten vertical identifiers for corresponding to the numbers 0-9 of a barcode, for example.

The conversion table can be used to convert a product identifier or barcode number to encoded form. The first number of the product identifier can be identified in the first column of the table, and the two-part encoded form established accordingly by the horizontal and vertical markers associated with that tabular position. Each subsequent number in the product identifier can be identified in each subsequent column, and the two-part encoded form of each number established.

The taggants may correspond to the characters or encoded characters by means of a table such as a lookup table or conversion table. The lookup table may include a list of the two-part encoded characters.

The lookup table provides a quick means of checking the taggant that corresponds to a particular character or encoded character.

It will be appreciated that any means of providing fixed correspondence or predetermined correlation between characters of the product identifier or barcode may be used, whether in the form of a conversion table (or lookup table) or some other form. In other words, a product identifier or barcode used as an input should result in an output as a combination of taggants specific to the characters of that identifier or barcode.

The conversion table (or other equivalent means) may be considered as providing a means of interconverting between the characters and the taggants.

For example, a flowchart or computer program may be used to process a product identifier or barcode to determine a combination of taggants. The conversion table, flowchart, computer program or other means may be used to convert or process each character individually, or subsets of characters, or the entire set of characters together, in order to generate or determine the combination of taggants specific to that product identifier or barcode.

The taggants used in the invention are preferably not luminophores, more preferably not luminophores having short-lived spectra such as fluorescence.

The product identifier may be comprised of characters selected from a set of ten different characters, such as the numbers 0-9. It will be appreciated that an alternate set (e.g. of 16 characters for 0-9 and A-F, a set of 26 characters for A-Z, or a set of 36 characters for A-Z and 0-9) may be used in some examples. The conversion table or lookup table can be set up accordingly.

Any taggants in the list should preferably be selected to be relatively stable in air and preferably selected to be relatively stable in the presence of water. This is intended to avoid the emission spectrum degrading or changing over time.

The list of taggants may comprise inorganic taggants or ceramic taggants.

The list may include an independent selection of one, some or all of the following: graphite, metal or oxide thereof, transition metal(s) or compound thereof (preferably oxide thereof or complex thereof), rare earth metal(s) or compound thereof (preferably oxide thereof or complex thereof), Sc or oxide/complex thereof, Ti or oxide/complex thereof, V or oxide/complex thereof, Cr or oxide/complex thereof, Mn or oxide/complex thereof, Fe or oxide/complex thereof, Co or oxide/complex thereof, Ni or oxide/complex thereof, Cu or oxide/complex thereof, Zn or oxide/complex thereof, Y or oxide/complex thereof, Zr or oxide/complex thereof, Nb or oxide/complex thereof, Mo or oxide/complex thereof, Ru or oxide/complex thereof, Rh or oxide/complex thereof, Pd or oxide/complex thereof, Ag or oxide/complex thereof, Cd or oxide/complex thereof, Hf or oxide/complex thereof, Ta or oxide/complex thereof, W or oxide/complex thereof, Re or oxide/complex thereof, Os or oxide/complex thereof, Ir or oxide/complex thereof, Pt or oxide/complex thereof, Au or oxide/complex thereof, Hg or oxide/complex thereof, La or oxide/complex thereof, Ce or oxide/complex thereof, Pr or oxide/complex thereof, Nd or oxide/complex thereof, Sm or oxide/complex thereof, Eu or oxide/complex thereof, Gd or oxide/complex thereof, Tb or oxide/complex thereof, Dy or oxide/complex thereof, Ho or oxide/complex thereof, Er or oxide/complex thereof, Tm or oxide/complex thereof, Yb or oxide/complex thereof, Lu or oxide/complex thereof, B or oxide thereof, Al or oxide thereof, Si or oxide thereof, P or oxide thereof, Ga or oxide thereof, Ge or oxide thereof, As or oxide thereof, Se or oxide thereof, In or oxide thereof, Sn or oxide thereof, Sb or oxide thereof, Te or oxide thereof, TI or oxide thereof, Pb or oxide thereof, Bi or oxide thereof.

It will be appreciated that any suitable compound including any of the above elements (including any independent selection of one, two, three or more of the elements) may be provided as a taggant, and oxides/complexes of the above are exemplary only.

Any of the above may independently be provided as any of: elemental form (for transition metal or rare earth element or any of the other elements), powder, particles or nanoparticles.

There may be one or a plurality of transition metal and/or rare earth metal based taggants (whether elemental, oxide or otherwise) in the list. Some compounds used as taggant may include multiple transition metals, multiple rare earth metals, or a combination of transition metal(s) and rare earth metal(s).

Various oxides may be preferred over other compounds for reasons of chemical stability.

In some examples, the list may comprise (or may only comprise) biocompatible or bio-tolerated taggants. This may be preferred for cases where the taggants are to be incorporated into products such as any of clothing, jewellery, food, drink, supplements, pharmaceuticals, or nutraceuticals, for example. It may be preferred for cases where the taggants are to be incorporated into products which will be touched or held by a person.

In some examples, the list may comprise (or may only comprise) taggants which are not flammable.

It will be appreciated that organic compounds may be included in the taggant list if they have an emission spectrum which includes one or more peaks. Organic compound(s) in the list may have a chromophore or chromophores. Preferably, any organic compound or other taggant in the list should be water-stable and/or air-stable.

It is envisaged that ‘transient’ or time-limited or temporary taggant(s) (whether organic or inorganic) could be employed as a form of timestamp or temporal barcode. Thus, some taggant(s) may be selected on the basis that they do degrade or change when exposed to one, some or all of: air (particularly oxygen), water and/or light (e.g. sunlight).

It will be appreciated that different sizes (or size ranges) of given particles/nanoparticles may be selected to provide taggants in the list which are based on the same element(s) but which provide distinct or differentiable emission spectra.

It will be appreciated that metals of different oxidation states may be selected to provide taggants in the list which are based on the same element(s) but which provide distinct or differentiable emission spectra.

Each taggant may be microscopic or substantially invisible to the naked eye.

The combination of taggants may include substantially ten or more different taggants. Preferably the combination of taggants includes any of: twelve or more different taggants, thirteen or more different taggants, fourteen or more different taggants, fifteen or more different taggants, twenty or more different taggants, twenty-five or more different taggants, thirty or more different taggants. In some examples, there may be even higher numbers (such as 40, 50, 60, 70, 80, 90, 100, 110, 120 or 130, or more) of taggants.

This allows for most or all of the digits in a conventional barcode to be represented. If digit order is disregarded, having ten taggants allows for each of the numbers 0-9 to be represented by a different taggant. If instead the taggants are selected to encode each product identifier character as well as its relative position within the product identifier, then having 15 taggants allows for all digits in a conventional 13-digit barcode to be represented by taggants, whilst also providing spare taggants for representing batch number or production year, for example.

In some cases, a given taggant A may be used to represent half of the possible character values in a given character position within the identifier, and a different taggant B may be used to represent the other half of the possible character values in a given character position within the identifier. For example, characters 0-4 inclusive may be represented by A and characters 5-9 inclusive may be represented by B. This may be repeated for some subsequent character positions (e.g. taggants C and D for character position 2; taggants E and F for character position 3; and so on).

This allows some or a majority of an identifier to be denoted by means of a relatively smaller pool of taggants.

Some characters, such as one, two or three characters (possibly end characters), of an identifier may still have a specific different taggant associated with each different possible character value to ensure a sufficiently large potential number of unique taggant combinations to accommodate current and future product identifiers.

For example, in the case of a 13-character barcode where each character position can have ten possible values (e.g. the numbers 0-9), having 11 of those characters each representable by a different pair of taggants (total of 22 different taggants) and the other two characters representable by different taggants (total of 20 different taggants) means that the barcode variations on the order of 2×10¹⁸ can be accommodated whilst minimising the number of different taggants required to put the invention into effect.

Where higher numbers of different taggants are provided in the list, and have spectra that are each suitably distinguishable (or resolvable) from each other, then even higher numbers of barcode variations can be accommodated. For example, using a 140 different taggants can provide 5×10²⁹ individually unique 13-digit barcodes with a standard ‘check sum’ ending.

Even a short 5-digit barcode (of 10 character possibilities per digit) may, if selecting from a 50 different taggants, have on the order of 2.5×10⁸ unique combinations.

The method may further comprise the step of determining one or more additional taggants corresponding to one or more secondary product identifiers selected from the group comprising: a batch identifier, a production date identifier, a country identifier, a manufacturer identifier.

Identifying batch number and/or any other relevant identifier can further specify the product and aid traceability, for example to check whether an old or out-of-date product was used. This can also aid in the case of product recall and/or replacement where defects are later discovered.

According to a second aspect of the invention, there is provided a method of manufacturing nanoparticles that specifically spectrally correspond to a pre-existing product identifier or barcode (for example by means of fixed character-to-taggant correspondence in a conversion table or equivalent), comprising determining a combination of taggants to encode the pre-existing product identifier or barcode according to the method of the first aspect, and manufacturing nanoparticles which comprise the determined combination of taggants.

The nanoparticles may be composite nanoparticles, each composite nanoparticle comprising each of the taggants in the determined combination of taggants.

According to a third aspect of the invention, there is provided a method of manufacturing or marking a product having a product identifier, comprising the method of the first aspect of the invention or providing the combination of taggants determined thereby, and adding or securing a combination of taggants in, on or to the product, thereby providing a marker (or covert marker) whose emission spectrum is usable to determine that the product is an authentic product.

The advantages are similar to the first and second aspects of the invention. Adding the product at the manufacturing stage allows the manufacturer to control the addition and position or distribution of the taggant combination within the product.

It will be appreciated that the method of the first aspect only needs to occur once for a particular product, and the subsequent manufacture of that product can occur multiple times without the need for repeating the method of the first aspect.

An apparatus may be provided for use in detecting emission spectra of the combination of taggants or the composite taggant(s). That is, detecting a product emission spectrum (which may include a taggant combination emission spectrum), and generating locally or remotely an authentication code based on that spectrum for assessing product authenticity, when the code is checked against a set or database of known product identifiers, which can lead to a pass/fail result for authenticity (or a near pass which may need further checking).

The apparatus can be used to obtain taggant emission spectra from a product (assuming taggant is present), such as a product which contains a taggant combination determined according to the first aspect of the invention. If no taggant is present, or if the wrong taggant(s) are present compared to the expected taggant(s), then this is readily identified by means of the apparatus which has the relevant processing means or is connected to/associated with a system having the relevant processing means. The apparatus can in some cases be adapted to have processing means for carrying out product authentication in situ, for example if the apparatus is part of an automated system. In other cases, the apparatus can be adapted to transmit data corresponding to the emission spectra to a system (such as a phone or computer) which is configured to carry out the product authentication. The results of the authentication may then be sent back to the apparatus for displaying whether the product is authentic or not, or possibly whether there is a near match for authenticity.

The term authentication code may be considered to mean an encoded form of a product identifier (such as a barcode). The authentication code may comprise characters or encoded characters. The authentication code can be decoded by a reverse process of the encoding process used in the first aspect of the invention. If the authentication code is converted or transformed into a product identifier which matches the expected product identifier, then the authentication code is valid. If the authentication code is converted or transformed into a product identifier which nearly matches the expected product identifier, then the authentication code may be valid and optionally further checks may be needed. If the authentication code is converted or transformed into a product identifier which does not substantially match the expected product identifier, then the authentication code is invalid.

An example of a conventional apparatus suitable for this purpose is the Agilent® 4300 Handheld FTIR spectrometer. It will be appreciated that this is not the only suitable option and other devices or scanners may be used, whether for IR detection or for UV detection, Raman detection or another spectral detection.

The handheld device may be provided for detecting the emission spectrum, and the processing means may be provided in a second device or system (such as a phone, tablet or computer). Authentication can thus be carried out remotely from the handheld device.

Alternatively, the emission spectrum may be detected and authenticated by a spectrophotometer and processing means comprised in a single apparatus. This can be more suitable for an automated system.

According to a fourth aspect of the invention, there is provided a method of assessing or determining whether a product is an authentic product or a non-authentic product, the authentic product being associated with a product identifier or barcode comprising a set of characters, in which a combination of taggants which correspond to the product identifier are contained in or on the authentic product but not the non-authentic product, the method comprising the steps of:
a) directing light (preferably infrared or near infrared) onto the product at one or more wavelengths for exciting taggant where present in the product;
b) detecting at least a portion of an emission spectrum (preferably an IR emission spectrum) of the product;
c) for peaks detected within the emission spectrum, encoding at least some of the peaks to generate a set of (encoded) characters as an authentication code; and
d) comparing the authentication code to a set of existing product identifiers of taggant-containing products for assessing product authenticity.

The advantages are similar to the preceding aspects of the invention. When the taggant combination (integral to the product) is scanned or read, then the resulting authentication code can be compared to predetermined, internationally-recognised product identifiers such as barcodes. This enables fast testing of a product to determine whether it is authentic, and for those results to optionally be displayed to the tester (typically on a timescale of a matter of seconds). The result may optionally be forwarded to another party, such as a regulatory authority.

The expected product may be provided or set as an input/reference (e.g. to an apparatus such as the Agilent® device mentioned above) prior to, during or after testing the product. The comparison output may then display whether the product which has been scanned does or does not match the expected product.

The method may further comprise the step of providing a comparison output identifying whether the authentication code corresponds to any of the existing product identifiers. That is, an expected product or product identifier may be provided, and the output may identify whether the authentication code corresponds to the expected product or product identifier.

The output may be a pass/fail result, or may indicate a near match, a list of possible matches, a product match or any other suitable result or output.

The output may include a visual or graphical output, for example on a display or screen. The output may include an audible sound, for example having different tones to indicate pass or fail.

If an exact match for the authentication code is found and corresponds to the expected result, then the output may display a ‘full match’ or ‘pass’ result, which may include the identity of the product and identifier which the authentication code matches. If a near match for the authentication code is found, then the output may display one or more ‘near match’ results, which may include the identity(ies) of the product(s) and identifier(s) which the authentication code nearly matches. Otherwise, a ‘non-match’ result may be displayed, which may include the identity of the product and identifier which the authentication code actually corresponds to.

A full match may be considered to be where all of the (encoded) characters in the authentication code, or decoded characters therefrom, correspond to all of the digits in the product identification code (identifier).

A near match may be considered to be where all but one of the encoded characters in the authentication code, or decoded characters therefrom, correspond to all but one of the digits in the product identification code (identifier).

A non-match may be considered to be where neither a full match nor a near-match applies.

Step (d) may include decoding or converting the authentication code into a product identifier. This may be done by a process corresponding to the reverse of the encoding process in the first aspect of the invention, or by checking the authentication code against a reference database containing taggant combinations and corresponding sets of (encoded) characters.

Alternatively, the product identifiers in a database may already have associated encoded forms, in which case the authentication code may be compared directly. However, in practice it is expected that the most common approach will be to convert the peaks or the authentication code to a product identifier, and then to compare the product identifier to a list or database of existing product identifiers.

Step (d) may include checking or searching a GTIN database or UPC database for the authentication code (or decoded form thereof).

The one or more detected peaks may be combined or concatenated in wavelength order, with respect to the detected wavelengths, to provide the authentication code. The one or more peaks may be combined or concatenated in alphabetical order or numerical order, with respect to the characters or encoded characters, to provide the authentication code.

This allows for the authentication code to correlate with a product identifier which is encoded in character order.

The detected peaks in the emission spectrum may be substantially in the range 400 nm to 800 nm and/or substantially in the range 700 nm to 1000 nm.

It will be appreciated that, in any of the above aspects, transmittance or absorption spectra may be contemplated for use instead of emission spectra, where appropriate. Another aspect of the invention is set out in claim 26. The advantages and optional features are similar to the first aspect.

Another aspect of the invention is set out in claim 27. The advantages and optional features are similar to the fourth aspect.

Any feature or features presented with respect to any aspect of the invention may be independently selected in isolation or in any independent combination and provided in any other aspect of the invention.

### BRIEF DESCRIPTION OF THE DRAWINGS

For a better understanding of the present invention, and to show more clearly how it may be carried into effect, reference will now be made by way of example only to the accompanying drawings, in which:

FIG. 1 shows a first embodiment of a barcode as a product identifier for a product;

FIG. 2 shows a conversion table for converting a barcode to an encoded form; and

FIG. 3 shows a variant of the conversion table of FIG. 2;

FIG. 4 shows examples of character pair strings for the barcode of FIG. 1 and table of FIG. 2;

FIG. 5 shows an example database having visible and hidden portions for the end user, for use in checking an emission spectrum-derived character pair string (or an authentication code) of a product against a list of authentic products and their corresponding product identifiers and authentic character pair strings;

FIG. 6 shows a second embodiment of a barcode; and

FIG. 7 shows a conversion table for the barcode of FIG. 6.

### DESCRIPTION OF PREFERRED EMBODIMENTS

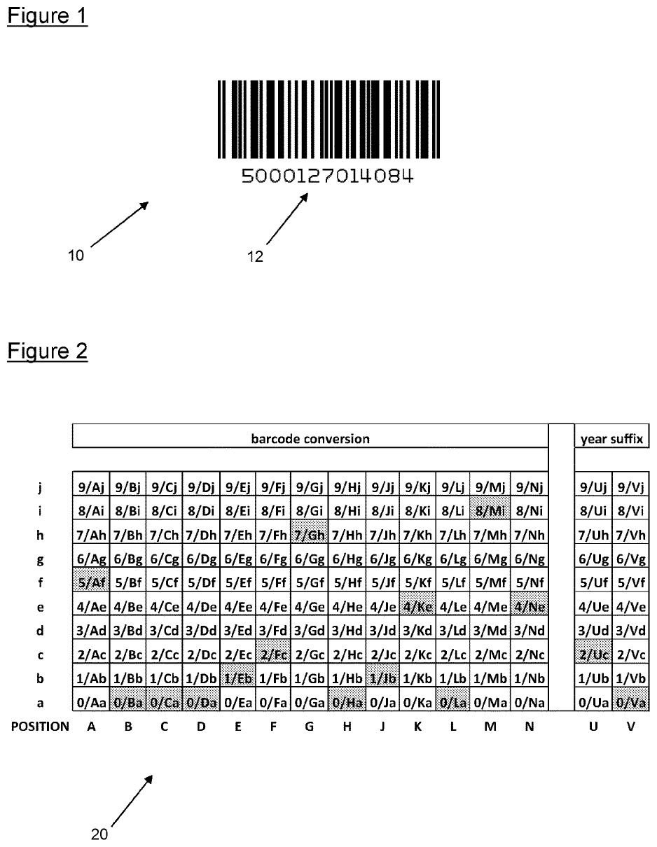

FIG. 1 shows an embodiment of a barcode, indicated generally at 10. The barcode 10 includes a set of thirteen characters “50001270014084”, indicated generally at 12. The barcode is an identifier corresponding to a particular product. It will be appreciated that whilst there are thirteen characters in the present barcode, any suitable number of characters may be present. It will also be appreciated that whilst the characters are all numbers in this embodiment, the identifier may in other embodiments comprise non-numeric characters.

FIG. 2 shows a conversion table, indicated generally at 20, for use in encoding the barcode of FIG. 1. Grey shaded cells are provided to indicate the conversion of the barcode characters into an encoded form.

For the first character of the barcode, the first column is used. The first character of the barcode is ‘5’. The row of the first column containing a cell beginning with ‘5’ is therefore applicable. The column and row identifiers form the two-part encoded form (‘Af’) of the first character.

For the second character of the barcode, the second column is used. The second character of the barcode is ‘0’. The row of the first column containing a cell beginning with ‘0’ is therefore applicable. The column and row identifiers form the two-part encoded form (‘Ba’), or encoded character pair, of the second character.

It will be appreciated that analogous steps are performed for each of the third to thirteenth characters of the barcode number. Note that zero (‘0’) is encoded in this embodiment.

In addition, the conversion table 20 in this embodiment has two additional columns for encoding a product year. For the year 2020, the abbreviation '20 is used, and so following the previous approach the conversion process yields the additional encoded characters ‘Uc’and ‘Va’.

The conversion table 20 contains 150 different encoded character pairs in this embodiment.

Once converted, the encoded pairs are provided in alphabetical order, due to the order of the pairs provided in the conversion table. This maintains the relative order of the characters in encoded form, although it will be appreciated that the encoded character pairs can be added together sequentially rather than prepared in isolation and later combined. The barcode characters in the present example are thus converted to the following code: AfBaCaDaEbFcGhHaJbKeLaMiNeUcVa

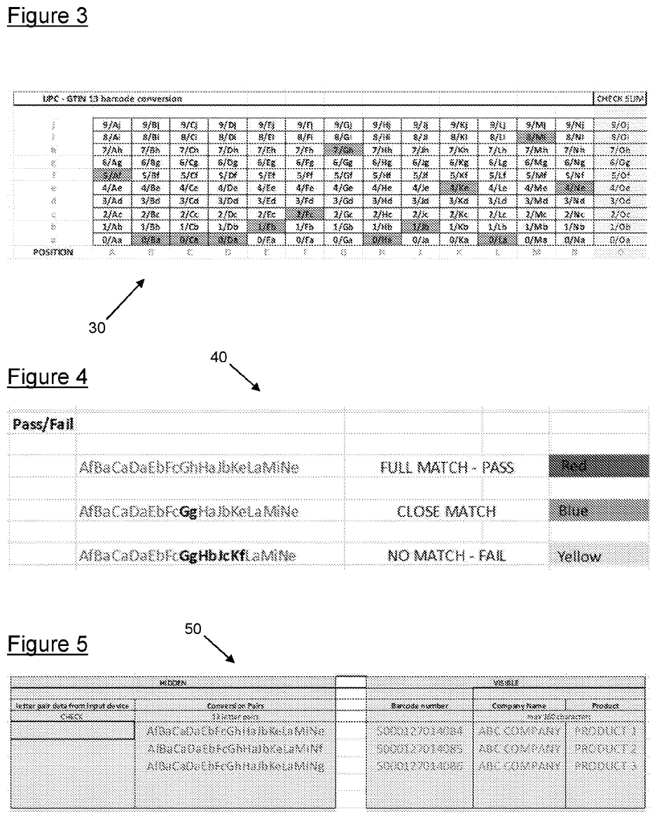

FIG. 3 illustrates a second embodiment of conversion table, indicated at 30. The table 30 is substantially similar to that of FIG. 2, but includes a ‘check sum’ column instead of two column for product year. The check sum can be used as a means of verifying that a valid combination of taggants has been detected.

FIG. 4 shows examples indicated generally at 40 of concatenated strings of encoded characters for the barcode of FIG. 1. The examples correspond to having a complete match (all 13 character pairs as expected), a close match (all but one of the character pairs match the expected values), and a failed match (in this only 9 character pairs match of the 13 expected pairs.

It will be appreciated that any single character pair may not match a corresponding product identifier character, and so generate a close match result. It will also be appreciated that any two or more character pairs may not match the corresponding number of product identifier characters, and so generate a failed result.

FIG. 5 shows an exemplary table or database (or similar), indicated generally at 50. The table 50 is not populated with much example data but it will be appreciated that it can be populated with all of the relevant barcode/product identifier strings, corresponding (encoded) character pairs, and optionally company names, product names and any other suitable data.

It will be appreciated that a real-world version of the database—particularly the (encoded) character pairs and the character pairs generated by detecting emission spectra of the combination of taggants—should be kept strictly confidential in order to avoid the fraudulent use in circumventing or reverse engineering the present invention.

In some embodiments, the database only contains the signatures of the composite taggant made from taggant materials listed in the relevant look-up table and therefore can only ‘see’the composite barcode taggants and nothing else.

Note that background noise can be removed before processing the data against the database, and this may provide relatively high intensity signals which allows accurate reading of the taggant identities.

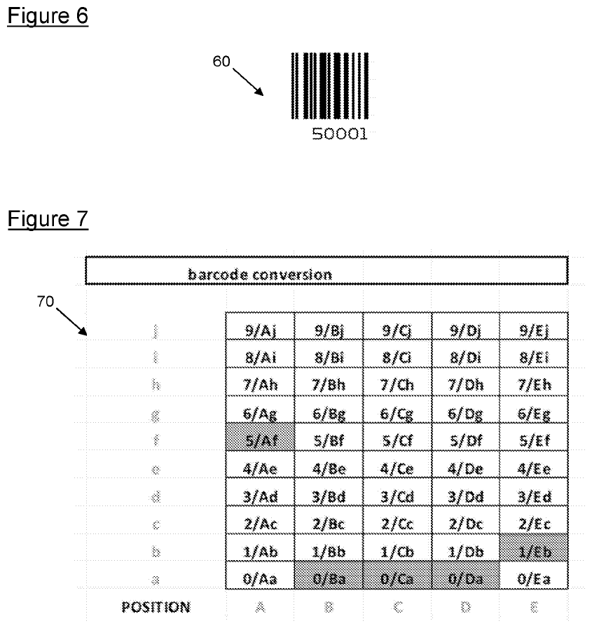

FIG. 6 shows a short-form barcode 60. In this example, the characters are the first five characters of the barcode 10, but it will be appreciated that any suitable characters may be used.

FIG. 7 shows a conversion or look-up table 70 corresponding to the short-form barcode 60. It will be appreciated that this is corresponding portion of the earlier table 20. The same principles apply in terms of how this version is used for establishing and/or checking product authenticity. The table 70 can be used in support of a huge number of different taggant combinations covering more than 2.5×10⁸ unique company barcode identifiers.

Any suitable plurality of taggants (or list of known taggants) may be provided for putting the invention into effect. It will be appreciated that the taggants may each be selected to be a different one of the various taggants discussed earlier in the specific description, whether that is zinc oxide, iron oxide, yttrium oxide, graphite, silver, or any other ones of the various taggants discussed above. For example, in the FIGS. 6-7 example, zinc oxide may represent 5/A a, iron oxide may represent 0/B a, yttrium oxide may represent 0/C a, graphite may represent 0/D a, and silver may represent 1/E b.

No inference about any limitation on the identities of the taggants should be taken from the very brief list of taggants explicitly named in the above paragraph, which are given purely as examples. The actual identity of each taggant is not critical, save that they are each different to each other taggant, and that the emission spectrum of each taggant has sufficiently distinguishable peaks so that it is ascertainable exactly which taggant a given peak must correspond to.

Each taggant will correspond specifically (and only) to a single character pair of the available combinations in the conversion tables. For example, the lookup table 20 includes 15 columns having 10 character pairs (in the form Xx), giving 150 different character pairs. Additional taggants can be provided in other embodiments, such as to encode batch number, and/or country code, for example. The character pairs in the embodiment of table 20 are respectively exclusively matched to taggants from the 150 different taggants.

Put another way, the encoded character pairs in each lookup table each correspond to unique taggants. It will be appreciated that some embodiments may have the same taggant appear in the lookup table more than once, but for different encoded character pairs (preferably different for both encoded characters in the encoded character pair).

It will also be appreciated that a conversion table designated for a real-world use should be kept confidential, in order that counterfeiters are not able to use it as part of a reverse engineering attempt. Otherwise, it would be necessary to start again with a new table of taggant to character pair correspondence which, whilst possible, would give rise to unnecessary overheads.

Having converted the barcode 10, 60 to an encoded form as above, taggants can be selected or determined according to the relevant table (when populated with the desired set of taggants) for each encoded character pair, to represent that pair in the actual product. The emission spectrum of each taggant should comprise one or more peaks which are distinguishable from those of each other taggant.

Once the combination of taggants has been determined, all of the taggants can be added to the product (normally during or immediately after manufacture), thereby marking it as an authentic product. This may be done by adding them individually or, if the combination of taggants are first provided as one or more composite particles (each containing at least two of the taggants), then in fewer steps than the number of individual taggants, which may be a single step of taggant addition or may be several steps.

The emission spectrum of the determined combination of taggants can then be recorded in a database.

Also, after the taggant combination has been determined, details of the encoded letter pairs can be entered into the database together with (where needed) reference data for the relevant product identifier or barcode, product name, company name, brand, and so on.

It is possible to prepare a composite taggant (or particles thereof) which have a composite emission spectrum or signature emission spectrum. That is, an emission spectrum which is unique to the combination of taggants used, where the emission spectrum arising from the composite taggant is different to a mere aggregation of individually obtained emission spectra of the various constituent taggants.

Once the composite taggant has been formed, the emission spectrum can be recorded in the database alongside the product identifier and its corresponding character pairs.

To obtain an emission spectrum of a product being tested for authenticity, a suitable device (such as the Agilent® device mentioned earlier in this specification) can be used with the correct database loaded or primed for access.

For example, the device can be engaged with dry paint on a painted wall (where paint is the product). The identity of the product itself is not yet known, although on some occasions the product may be expected to be a particular product. If a particular product is expected, this may be inputted at any stage.

Once the emission spectrum has been acquired, or as it is acquired, the device can either transmit data about relevant parts of the emission spectrum to a secondary device (that has or has access to the database) for processing and analysing the spectrum, or alternatively it can compare the relevant peaks to a database it holds or has access to, e.g. after converting the relevant parts to an authentication code of character pairs. If taggant is present in the product, then the emission spectrum will contain peaks or emissions which correspond to the taggants.

For example, if silver nanoparticles are present, then excitation at 420 nm can in some cases yield an emission at 485 nm or 550 nm. Where a combination of taggants is present, then excitation at 365 nm or 420 nm can yield a plurality of emissions corresponding to each of the taggants.

Distinct peaks can be identified from the detected emission spectrum and converted via the relevant lookup table into a series of encoded letter pairs. The encoded letter pairs are put together in a string in a suitable order. Using the earlier example of FIGS. 1-2, if an authentic product is present and so contains the required taggants, this would generate emission peaks for the 15 different taggants which can be converted to the following string as an authentication code: AfBaCaDaEbFcGhHaJbKeLaMiNeUcVa.

This code can be decoded by the secondary device to provide “50001270014084” as a product identifier or barcode. The barcode can be checked against a GTIN or UPC database to identify the product and manufacturer, as well as the manufacturing date. If there was an expected product prior to commencing the analysis, the results obtained from the database can be used to manually determine whether the product is the correct one. Alternatively, if the expected product was input into the device or secondary device, then an output may be generated to signify there is a full match and the product corresponds to the one expected, i.e. the product is confirmed as authentic.

In a first alternative scenario (see FIG. 4), the product being tested may when excited generate emission peaks which correspond to the following authentication code: AfBaCaDaEbFcGgHaJbKeLaMiNeUcVa. The middle encoded character pair “Gg” is shown in bold and underlined because it does not exactly match the expected encoded character pair “Gh”. However, all of the other encoded character pairs do convert to the correct barcode characters for the barcode of FIG. 1. In this case, an output can be generated to signify there is a near match and the user may be presented with a list of possible product matches having product identifiers which correspond to all but the erroneous encoded character pair.

In a second alternative scenario (again see FIG. 4), the product being tested may when excited generate emission peaks which correspond to the following authentication code: AfBaCaDaEbFcGgHbJcKfLaMiNeUcVa. The middle encoded character pair “Gg” is shown in bold and underlined because it does not match the expected encoded character pairs “GhHaJbKe”. In this case, an output can be generated to signify there is a no match and the product fails authentication.

If there are not enough taggant signatures for a full match or near match, but the user has not set an expected product or identifier to match to, then the device may display a list of possible products for the user to consider as possible matches. For example, if—purely as an example of system behaviour and not in the intended scope of protection—only silver nanoparticles are present and no other taggants, then the authentication code would be “Hf” (for 550 nm). Relative intensity of the emission may also be provided for checking the amount of silver nanoparticle which is still present in its original form in the product. The user would be provided with a list of possible products which have been registered as containing the silver nanoparticles.

The embodiments described above are provided by way of example only, and various changes and modifications will be apparent to persons skilled in the art without departing from the scope of the present invention as defined by the appended claims.

1. A method of encoding a pre-existing product identifier or barcode for an authentic product by determining a combination of taggants to spectrally correspond to that pre-existing product identifier or barcode, the method comprising the steps of:
a) providing the pre-existing product identifier or barcode for the product, the pre-existing product identifier or barcode comprising a set of characters which is specific to the product;
b) providing a list of a plurality of different taggants, where each taggant has an emission spectrum comprising one or more peaks, and the one or more peaks in the emission spectrum of a given taggant in the list are substantially distinguishable from the one or more peaks of emission spectra of the other taggants in the list;
c) assigning a taggant from the list to each character of the pre-existing product identifier or barcode from (a), each character thereby being associated with a different taggant for establishing fixed correspondence between the assigned taggants and the respective characters of the pre-existing product identifier or barcode, for reference in subsequent addition of the combination of assigned taggants to a product to spectrally denote the pre-existing product identifier or barcode; and
d) obtaining or recording an infrared emission spectrum or signature of the combination of assigned taggants for pairing with the pre-existing product identifier or barcode.

2. The method as claimed in claim 1, including, prior to (c), the step of encoding part or all of the set of characters of the product identifier to provide a set of encoded characters, and in which the assigning step is assigning a taggant from the list to each encoded character.

3. The method as claimed in claim 1, in which the pre-existing product identifier or barcode is in a database, such as a GTIN or UPC database, and the pre-existing product identifier or barcode has been pre-assigned to the authentic product.

4. The method as claimed in claim 1, in which the infrared emission spectrum of the taggants is recorded using FTIR and/or excitation wavelengths in the range 950 nm to 25000 nm for use in identifying the combination of taggants.

5. The method as claimed in claim 2, including one or both of:
each character is encoded to a two-part encoded character based on its character identity or value and also on its position within the order of characters in the product identifier; and
the taggants correspond to the encoded characters by means of a lookup table.

6. The method as claimed in claim 5, in which each character is encoded during (c) by means of any one of a conversion table, a flowchart, a computer program or another means for the characters of the pre-existing product identifier or barcode to have fixed or predetermined correspondence to the taggants in the list of taggants.

7. The method as claimed in claim 6, in which the conversion table contains a set of two-part encoded characters for converting the pre-existing product identifier or barcode to encoded form, a first part of each encoded character pair corresponding to one of i) the identity or value of each character and ii) the position of the character within the order of characters, and a second part of each encoded character pair corresponding to the other of i) and ii).

8. (canceled)

9. The method as claimed in claim 6, in which the combination of taggants includes ten or more different compounds as taggants in nanoparticle form, and in which the conversion table includes ten or more different taggants or twelve to fifteen or more different inorganic or ceramic taggants.

10. (canceled)

11. The method as claimed in claim 1, further comprising the step of determining one or more additional taggants to include in the combination, the one or more additional taggants corresponding to one or more secondary product identifiers selected from the group comprising: a batch identifier, a production date identifier, a country identifier, a manufacturer identifier.

12. The method as claimed in claim 1, in which the taggants are comprise any one or more of: inorganic taggants, ceramic taggants, metal oxides and/or metalloid oxides.

13. (canceled)

14. The method as claimed in claim 1, in which (d) excludes obtaining or recording one or both of: an ultraviolet light spectrum of the combination of taggants, and a visible light spectrum of the combination of taggants.

15. A method of manufacturing nanoparticles to spectrally correspond to a pre-existing product identifier or barcode, comprising determining a combination of taggants to encode the pre-existing product identifier or barcode according to the method of claim 1, and manufacturing nanoparticles which comprise the determined combination of taggants.

16. The method as claimed in claim 15, in which the nanoparticles are composite nanoparticles, each composite nanoparticle comprising each of the taggants in the determined combination of taggants.

17. The method of claim 16 in manufacturing or marking a product having a product identifier, comprising adding or securing the nanoparticles comprising the combination of taggants in, on or to the product, thereby providing a marker whose emission spectrum is usable to determine that the product is an authentic product.

18. The method as claimed in claim 17, as a method of manufacturing or marking one or more of: aircraft parts and/or aerospace components, military parts and/or components.

19. (canceled)

20. (canceled)

21. A method of assessing whether a product is an authentic product or a non-authentic product, the authentic product being associated with a product identifier or barcode comprising a set of characters, in which a combination of taggants which correspond to the product identifier are contained in or on the authentic product but not the non-authentic product, the method comprising the steps of:
a) directing infrared light onto the product at one or more wavelengths for exciting taggant where present in the product;
b) detecting at least a portion of an infrared emission spectrum of the product;
c) for peaks detected within the infrared emission spectrum, encoding at least some of the peaks to generate an authentication code; and
d) comparing the authentication code to a set of existing product identifiers of taggant-containing products for assessing product authenticity.

22. The method as claimed in claim 21, in which step (d) includes checking for the authentication code in a GTIN database or UPC database.

23. The method as claimed in claim 21, further comprising the steps of inputting an expected product or product identifier, and providing an output indicating whether the authentication code corresponds to the inputted product or product identifier.

24. The method as claimed in claim 21, in which during encoding the one or more peaks are combined or concatenated in peak wavelength order, character alphabetical order or character numerical order to provide the authentication code.

25. The method as claimed in claim 21, in which steps (a) and (b) are carried out using FTIR and/or in which the light has excitation wavelengths substantially in the range 950 nm to 25000 nm.

26. (canceled)

27. (canceled)
